(19) United States
(12) Patent Application Publication
(10) Pub. No.: US 2009/0292561 A1
(43) Pub. Date: Nov. 26, 2009

(54) MEDICAL INFORMATION ACCESS CONTROL APPARATUS AND MEDICAL INFORMATION ACCESS CONTROL PROGRAM

(75) Inventor: Keiichi ITOH, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/272,284

(22) Filed: Nov. 17, 2008

(30) Foreign Application Priority Data
May 21, 2008 (JP) 2008-132988

(51) Int. Cl. G06Q 50/00

(52) U.S. Cl. 705/3

(57) ABSTRACT

A medical information access control apparatus including a first storage that stores information of a first access right and a second access right, a second storage that stores a determination information that determines whether or not a patient is in an emergency medical condition, an accepting unit that accepts an access request to the medical information of the patient, an acquiring unit that acquires a state information of the patient, a determining unit that determines whether or not the patient is in the emergency medical condition, and a controller that performs an access control to the medical information based on the first access right if the determining unit determines that the patient is not in the emergency medical condition and based on the second access right if the determining unit determines that the patient is in the emergency medical condition.

### CROSS-REFERENCE TO RELATED APPLICATIONS

This application is based on and claims priority under 35 U.S.C. 119 from Japanese Patent Application No. 2008-132988 filed May 21, 2008.

### BACKGROUND

1. Technical Field

This invention relates to a medical information access control apparatus and a medical information access control program.

2. Related Art

In recent years, a system for managing medical information of a patient using a computer has been proposed. In such a medical information management system, access control is performed, for example, in such a manner that the doctor in charge of a patient (attending physician, etc.,) is permitted to access the medical information of the patient (view, read, edit, etc.,) and any other doctor than the doctor in charge of the patient is prohibited from accessing the medical information of the patient.

By the way, if the doctor in charge of the patient is absent in an emergency medical condition for the patient (for example, when the patient is in a critical condition), it becomes necessary for even any other doctor than the doctor in charge of the patient to read the medical information of the patient. Thus, inconvenience occurs if only uniform access control responsive to whether or not the doctor is the doctor in charge of the patient is applied as described above.

As the invention relating to the medical information management system, the following is proposed: The medical information providing request mode is determined and if the mode is determined as an emergency mode or a disaster mode, a login code or a password used when a doctor or a specific medical institution makes a request for providing the doctor or the medical institution with medical information for supporting the life of the patient is issued to the doctor or the specific medical institution.

### SUMMARY

According to an aspect of the present invention, there is provided a medical information access control apparatus comprising:

a first storage that stores information of a first access right to medical information of a patient and information of a second access right which has more relaxed limit range than the first access right;

a second storage that stores a determination information that determines whether or not the patient is in an emergency medical condition;

an accepting unit that accepts an access request to the medical information of the patient;

an acquiring unit that acquires a state information which is related to a condition of a patient involved in the medical information requested to be accessed;

a determining unit that determines whether or not the patient involved in the medical information is in the emergency medical condition based on the state information and the determination information; and

a controller that performs an access control to the medical information requested to be accessed based on the first access right if the determining unit determines that the patient involved in the medical information is not in the emergency medical condition, and performs the access control to the medical information requested to be accessed based on the second access right if the determining unit determines that the patient involved in the medical information is in the emergency medical condition.

### BRIEF DESCRIPTION OF THE DRAWINGS

Exemplary embodiment of the present invention will be described in detail based on the following figures, wherein:

FIG. 1 is an outline drawing of a medical information management system according to an exemplary embodiment of the invention;

FIG. 2 shows a patient ID read example according to the embodiment of the invention;

FIG. 3 is a functional block diagram of a medical information management apparatus according to the exemplary embodiment of the invention;

FIG. 4 shows an example of access right information according to the exemplary embodiment of the invention;

FIG. 5 shows an example of setting a place where it is estimated that a patient is in an emergency medical condition according to the exemplary embodiment of the invention;

FIG. 6 shows an example of a processing flow of access control to the medical information of a patient according to the exemplary embodiment of the invention; and

FIG. 7 is a block diagram to show the hardware configuration of the medical information management apparatus according to the embodiment of the invention.

### DETAILED DESCRIPTION

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

The invention will be discussed specifically based on one exemplary embodiment illustrated below:

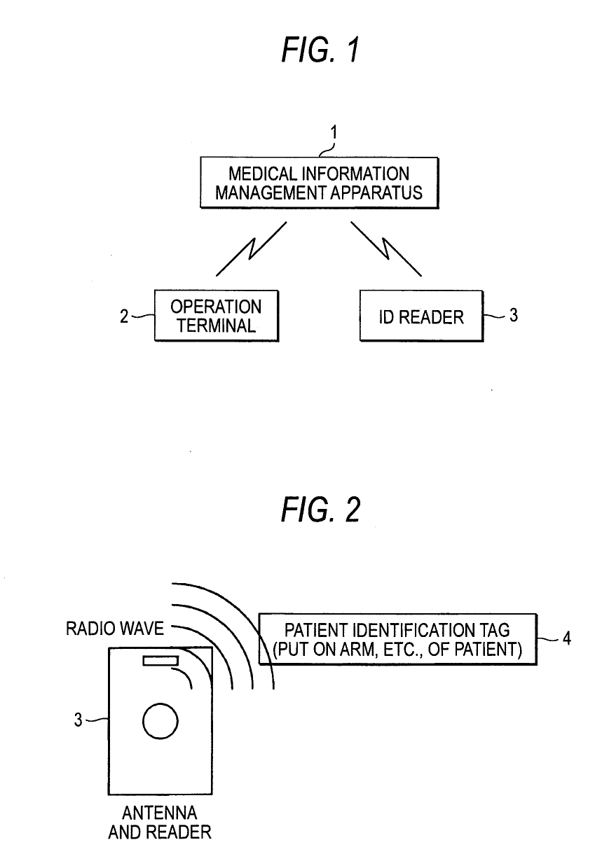

A medical information management system of the exemplary embodiment includes a medical information management apparatus 1, an operation terminal 2, and an ID reader 3, as shown in FIG. 1.

The operation terminal 2 sends an access request to medical information of a patient to the medical information management apparatus 1 in response to manipulated input accepted from the user (a health care provider such as a doctor, a nurse, or a pharmacist) using an input device of a keyboard, a mouse, etc., receives the medical information from the medical information management apparatus 1, and presents (displays) the medical information to the user on a display such as a liquid crystal display.

In FIG. 1, one operation terminal 2 is shown representatively, but any number of operation terminals 2 are installed in response to the system environment.

The ID reader 3 acquires patient identification information (hereinafter, patient ID) from a patient identification label 4 (patient identification tag, patient registration card, name tag, wrist band, etc.,) assigned to each patient (see an example shown in FIG. 2). The patient ID may be acquired by various methods; for example, the patient ID stored on the patient identification tag put on an arm, etc., of the patient or the patient registration card possessed by the patient is read and acquired by conducting non-contact communications, for example, an image proper to the patient printed on the name tag or the wrist band put on the patient (bar code information, etc.,) is optically read and is acquired.

In FIG. 1, one ID reader 3 is shown representatively, but any numbers of ID readers 3 are installed in response to the system environment.

The patient ID acquired as described above is transmitted to the medical information management apparatus 1 together with location information of the ID reader 3 and is used to determine the place where the patient exists at present. For example, the number of the hospital room or the number of the bed where the ID reader 3 is installed is used as the location information of the ID reader 3. In the exemplary embodiment, the location information previously stored in the ID reader 3 is transmitted. However, identification information of the apparatus previously stored in the ID reader 3 (which will be hereinafter referred to as apparatus ID) may be transmitted to the medical information management apparatus 1, which may then acquire the location information of the ID reader 3 by referencing a preset correspondence table between the apparatus IDs and the location information. If the ID reader 3 is a mobile terminal, the position coordinates at the patient ID reading time may be determined by a function of the ID reader 3 (for example, GPS (Global Positioning System)) and may be transmitted to the medical information management apparatus 1 as the location information.

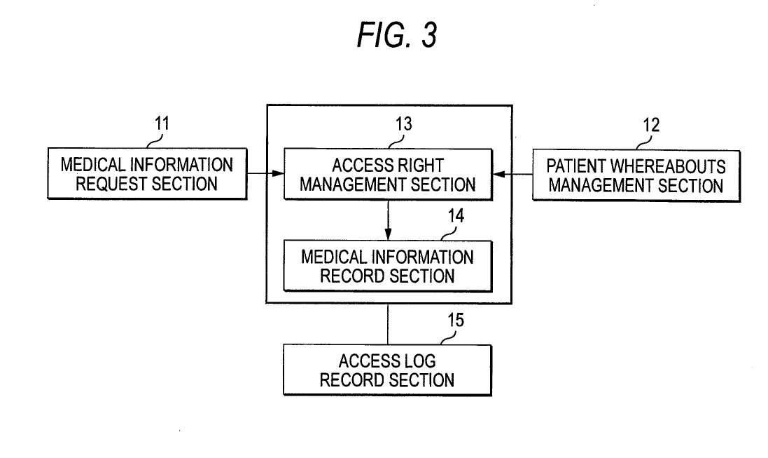

The medical information management apparatus 1 manages medical information of patients and includes a medical information request section 11 that accepts an access request to a medical document, a patient whereabouts management section 12 that manages patient's whereabouts, an access right management section 13 that performs access control to a medical document, a medical information record section 14 that stores medical information, and an access log record section 15 that stores an access log to medical information, as shown in FIG. 3 (functional block diagram).

In FIG. 1, one medical information management apparatus 1 includes the functional sections 11 to 15, but the functional sections may be distributed to two or more apparatus.

The patient whereabouts management section 12 manages the whereabouts of each patient based on the patient ID and the location information transmitted from the ID reader 3. In the exemplary embodiment, the patient ID and the location information are stored in association with each other and when the patient ID and the location information are received from the ID reader 3, the information corresponding to the reception description (the received patient ID and the location information associated with the identical patient ID) is updated so as to be able to keep track of the place where each patient exists at present in real time.

The access right management section 13 manages the access right to the medical information of each patient according to the two types of access types: Ordinary access right applied at the ordinary time and emergency access right applied at the emergency time. The emergency access right has more relaxed limit range than the ordinary access right. In the description to follow, the access right means the reference (read) right of medical information, but may be the registration (new creation) right, the update right, the deletion right, etc., of medical information.

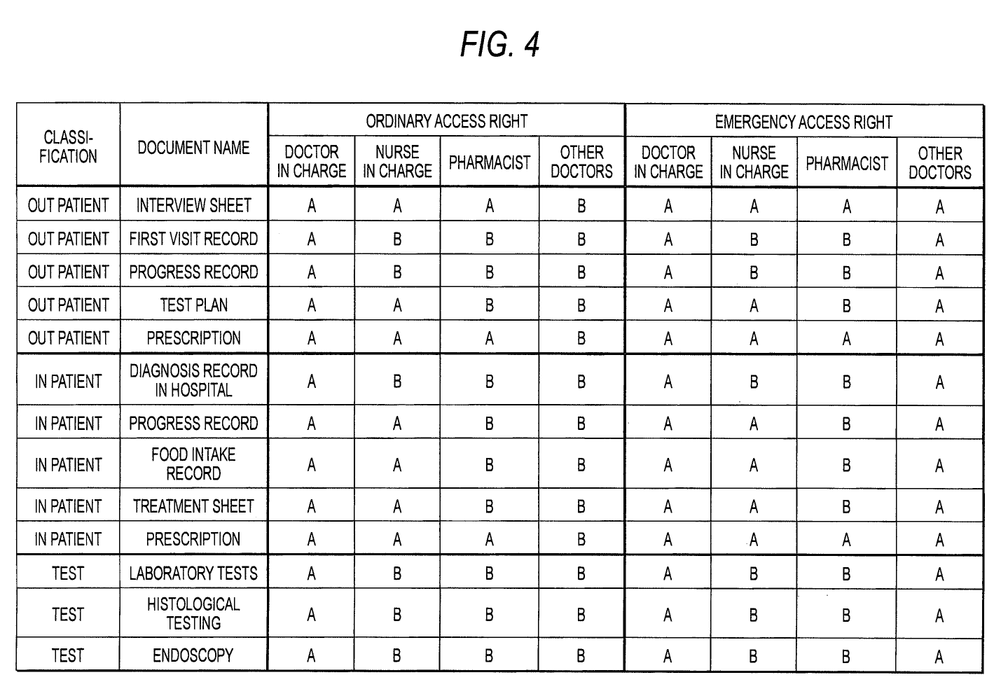

The access right management section 13 in the exemplary embodiment defines the ordinary access right and the emergency access right by job category of the user, such as a doctor in charge, a nurse in charge, a pharmacist, or other doctors, for each type of medical information made up of classification and document name, as shown in FIG. 4 to show an example of access right information. In FIG. 4 the mark A means accessible and the mark B means impossible to access. According to FIG. 4, it is defined that the doctor in charge can access all of the medical information of one patient, the nurse in charge and a pharmacist can access some of the medical information, and other doctors (doctors other than the doctor in charge) can access none of the medical information at the ordinary time. On the other hand, it is defined that doctors (the doctor in charge and other doctors) can access all of the medical information of one patient and the nurse in charge and a pharmacist can access some of the medical information at the emergency time. That is, the limitation is relaxed at the emergency time so that each doctor can access the medical information of the patient equally regardless of whether or not the doctor is the doctor in charge of the patient.

The settings described above are only one example; at the emergency time, the limitation on the access right of a health care provider except other doctors (nurse in charge, pharmacist, etc.,) may be loosened. The access right by any other attribute (for example, assignment section) rather than the access right by job category of the user as described above may be set or the access right of each individual user may be set.

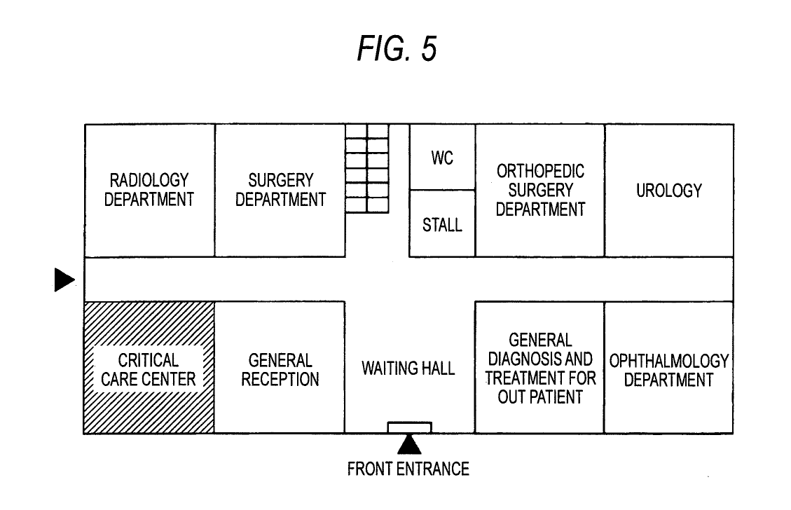

The access right management section 13 stores emergency condition determination information to determine whether or not the patient is in an emergency condition in addition to the access right information described above. In the embodiment, information of the place where it is estimated that the patient in the place is in an emergency medical condition, such as a critical care center or an operating room, is stored as the emergency condition determination information. FIG. 5 illustrates the case where a critical care center is set as the emergency condition determination information (information of a place where emergency mode access is required).

The setting is not limited to such setting in room units and may be setting responsive to the management mode of patient's whereabouts by the patient whereabouts management section 12 (the acquisition mode of location information through the ID reader 3); for example, the setting may be made in bed units of each hospital room or in units of partitions separated with 30 cm spacing.

When the medical information request section 11 accepts an access request, the access right management section 13 determines whether or not the patient involved in the medical information requested to be accessed is in an emergency condition based on the patient whereabouts management section 12 and the emergency condition determination information, and applies either the ordinary access right or the emergency access right in response to the determination result, thereby performing access control to the medical information.

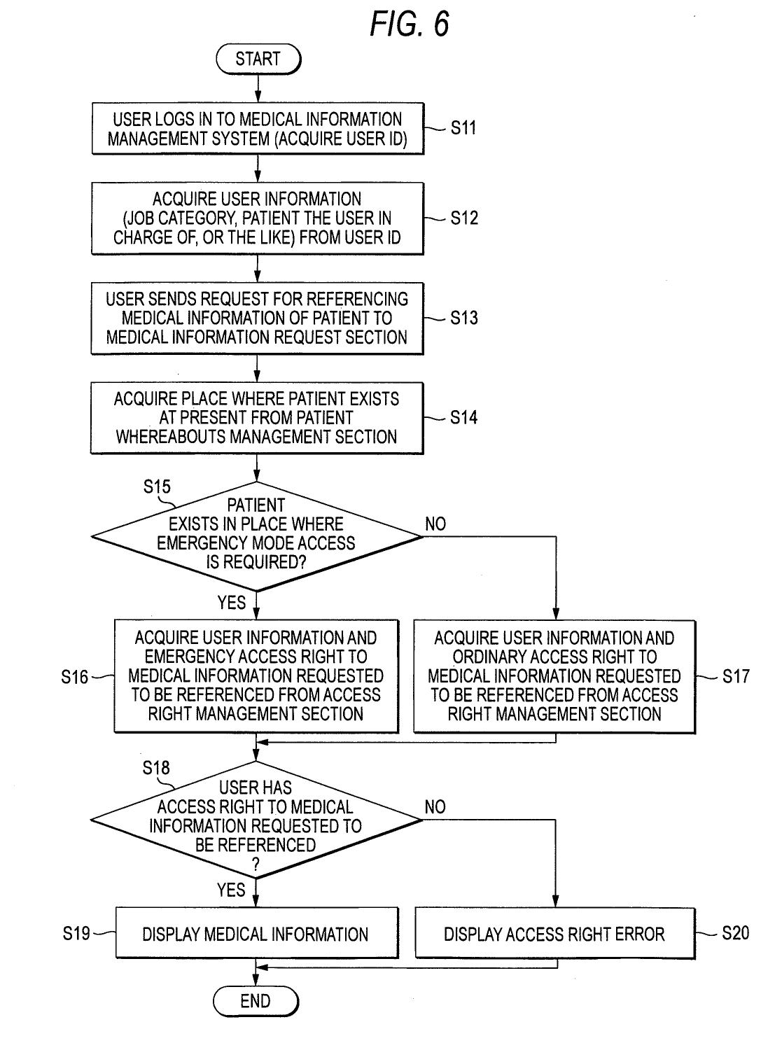

FIG. 6 shows an exemplary example of a processing flow of the access control to the medical information of a patient.

When the user logs in to the medical information management system using the operation terminal 2, the identification information of the user (hereinafter, the user ID) transmitted from the operation terminal 2 accordingly is received (acquired) by the medical information management apparatus 1 (step S11) and the user information responsive to the user ID (the job category, the patient the user in charge of, or the like) is acquired (step S12).

Then, if the user makes an access request (reference request) to the medical information of the patient using the operation terminal 2, the description of the request is accepted by the medical information request section 11 of the medical information management apparatus 1 (step S13).

The access right management section 13 sends inquiry about the place where the patient involved in the medical information requested to be accessed exists at present to the patient whereabouts management section 12 and acquires information of the place (step S14) and determines whether or not the acquired place information is set as the emergency condition determination information (information of a place where emergency mode access is required), in other words, whether or not the patient exists in a place where emergency mode access is required (step S15).

If the patient exists in a place where emergency mode access is required (if the acquired place information is set as the emergency condition determination information), the user information and the information of the emergency access right to the medical information requested to be accessed (requested to be referenced) are acquired (step S16); if the patient does not exist in a place where emergency mode access is required (if the acquired place information is not set as the emergency condition determination information), the user information and the information of the ordinary access right to the medical information requested to be accessed (requested to be referenced) are acquired (step S17).

Whether or not the user has the access right (reference right) to the medical information is determined based on the acquired user information and the acquired information of the emergency access right to the medical information (step S18) If the user has the access right (reference right), the corresponding medical information is transmitted to the requesting operation terminal 2 for displaying the medical information (S19). If the user does not have the access right (reference right), information indicating that the user does not have the access right is transmitted to the requesting operation terminal 2 for displaying an error message (S20).

In the system of the exemplary embodiment, various mechanisms for ensuring security in the emergency mode are provided.

Specifically, if the access request is not an access request received from a specific terminal (such as a terminal in the critical care center), control is performed so that emergency mode access (access control to which the emergency access right is applied) is not executed. That is, when the access request is an access request received from any other terminal than the specific terminal, even if it is determined that the patient is in an emergency condition, emergency mode access is not executed and ordinary mode access (access control to which the ordinary access right is applied) is executed.

The system also has a function of notifying a predetermined user (for example, manager) that the patient has been placed in an emergency condition.

The system also has a function of recording information indicating that emergency mode access has been made to medical information in an access log to the medical information.

In the exemplary embodiment described above, whether or not the patient is in an emergency condition is determined based on the place where the patient exists, but may be determined according to another technique.

For example, whether or not the patient is in an emergency condition is determined based on the medical apparatus connected to the patient. That is, the medical apparatus connected to the patient when the patient is in an emergency medical condition is previously determined and it is determined that the patient to whom the medical apparatus is connected is in an emergency condition.

Specifically, the information indicating the medical apparatus (for example, a heart rate meter) is previously stored in the access right management section 13 as the emergency condition determination information. The information indicating the medical apparatus connected to the patient is acquired and is determined whether or not the acquired information indicating the medical apparatus is set as the emergency condition determination information. If the information is set as the emergency condition determination information, it is determined that the patient is in an emergency condition; if the information is not set as the emergency condition determination information, it is determined that the patient is not in an emergency condition.

The medical apparatus connected to the patient may be determined in various modes. For example, the medical apparatus is provided with the function of the ID reader 3 and is caused to read the patient ID from the patient identification label put on the patient connected to the medical apparatus and is caused to transmit the patient ID to the medical information management apparatus 1 together with the location information of the medical apparatus. Alternatively, the medical apparatus is provided with an input section of the patient ID and is caused to transmit the entered patient ID to the medical information management apparatus 1 together with the location information of the medical apparatus.

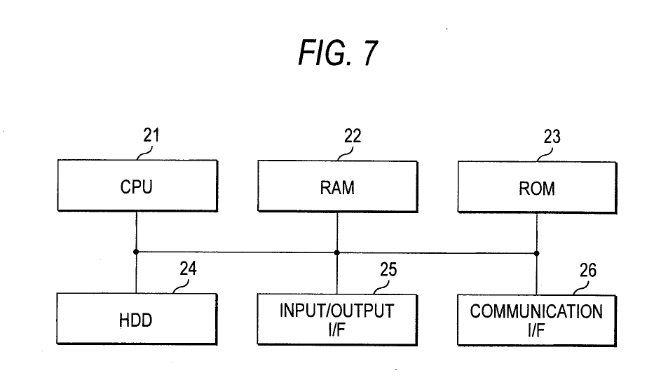

FIG. 7 shows the main hardware configuration of a computer that implements the medical information management apparatus 1 of the exemplary embodiment.

That is, the medical information management apparatus 1 is implemented as a computer having the hardware resources such as a CPU 21 that performs various types of computation processing, RAM 22 used as a work area of the CPU 21, ROM 23 that stores a basic control program, an HDD 24 that stores programs and various pieces of data for providing the functions according to the invention, an input/output I/F 25 of an interface with a display screen that displays information for the user and devices of a mouse, a keyboard, etc., for accepting information input from the user, and a communication I/F 26 of an interface for conducting communications with other apparatus.

Specifically, the program according to the invention is read from the HDD 24 and is expanded in the RAM 22 and is executed by the CPU 21, whereby the function means according to the invention is provided by the computer.

In the exemplary embodiment, the medical information request section 11 mainly implements accepting unit according to the invention, the patient whereabouts management section 12 mainly implements acquiring unit according to the invention, and the access right management section 13 mainly implements first storage, second storage, determining unit, and controller according to the invention.

The program according to the invention is provided for the licensee of the invention, for example, in such a manner that an external storage medium of a CD-ROM, etc., storing the program is distributed or that the program is distributed through a network.

The function means according to the invention may be provided not only by the software as in the exemplary embodiment, but also by dedicated hardware modules.

What is claimed is:

1. A medical information access control apparatus comprising:
a first storage that stores information of a first access right to medical information of a patient and information of a second access right which has more relaxed limit range than the first access right;
a second storage that stores a determination information that determines whether or not the patient is in an emergency medical condition;
an accepting unit that accepts an access request to the medical information of the patient;
an acquiring unit that acquires a state information which is related to a condition of a patient involved in the medical information requested to be accessed;
a determining unit that determines whether or not the patient involved in the medical information is in the emergency medical condition based on the state information and the determination information; and
a controller that performs an access control to the medical information requested to be accessed based on the first access right if the determining unit determines that the patient involved in the medical information is not in the emergency medical condition, and performs the access control to the medical information requested to be accessed based on the second access right if the determining unit determines that the patient involved in the medical information is in the emergency medical condition.

2. The medical information access control apparatus as claimed in claim 1, wherein
the determination information indicates a predetermined place, wherein
the state information indicates the place where the patient involved in the medical information exists, and wherein
if the state information is corresponded to the determination information, the determination determines that the patient involved in the medical information is in the emergency medical condition.

3. The medical information access control apparatus as claimed in claim 1,
wherein the determination information indicates a predetermined medical apparatus, wherein
the state information indicates the medical apparatus connected to the patient involved in the medical information, and wherein
if the state information is corresponded to the determination information, the determination determines that the patient involved in the medical information is in the emergency medical condition.

4. The medical information access control apparatus as claimed in claim 1,
wherein the first storage stores a plurality of pieces of information of the first access right and the second access right in association with each of health care providers, and wherein
the control performs access control to the medical information requested to be accessed based on the first access right or the second access right associated with each of the health care providers making the access request.

5. The medical information access control apparatus as claimed in claim 1,
wherein when the access request is an access request received from any other terminal than a specific terminal, even if it is determined that the patient involved in the medical information requested to be accessed is in the emergency medical condition, the control does not perform access control based on the second access right and performs access control based on the first access right.

6. A computer readable medium storing a program causing to execute a process for performing a medical information access control, the process comprising:
accepting an access request to a medical information of a patient;
acquiring state information relating to a condition of a patient involved in the medical information receiving the access request;
determining whether or not the patient involved in the medical information is in an emergency medical condition based on the state information and a determination information to determine whether or not the patient is in the emergency medical condition; and
performing access control to the medical information requested to be accessed based on a first access right to the medical information of the patient if it is determined that the patient involved in the medical information is not in the emergency medical condition and performing access control to the medical information requested to be accessed based on a second access right which has a relaxed limit range than the first access right if it is determined that the patient involved in the medical information is in the emergency medical condition.
